(19) United States
(12) Patent Application Publication
(10) Pub. No.: US 2010/0304617 A1
(43) Pub. Date: Dec. 2, 2010

(54) RJ-45 CONNECTOR AND LATCHING DEVICE THEREOF

(75) Inventors: XIAO-FENG MA, Shenzhen City (CN); LEI LIU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/490,339

(22) Filed: Jun. 24, 2009

(30) Foreign Application Priority Data
May 27, 2009 (CN) 200910302692.4

(51) Int. Cl. H01R 24/00; H01R 13/64

(52) U.S. Cl. 439/676; 439/680

(57) ABSTRACT

A Registered Jack-45 (RJ-45) connector includes a main body and a latching device to detachably engage the main body. The latching device includes a fixing element and an elastic latching element positioned on the fixing element.

### BACKGROUND

1. Technical Field

The present disclosure relates to a Registered Jack-45 (RJ-45) connector.

2. Description of Related Art

RJ-45 connectors are used for data communication purposes. In use, a latching element of the RJ-45 connector is engaged into an inserting interface to communicate. At present, commonly used RJ-45 connectors is integrally structured. If the latching element of the RJ-45 connector has been broken, the RJ-45 of the connector cannot be used anymore, and must be changed, creating material waste.

### BRIEF DESCRIPTION OF THE DRAWINGS

FIG. 1 is an exploded, isometric view of an exemplary embodiment of an RJ-45 connector.

FIG. 2 is an inverted view of the RJ-45 connector of FIG. 1.

FIG. 3 is an assembled, isometric view of the RJ-45 connector of FIG. 1.

### DETAILED DESCRIPTION

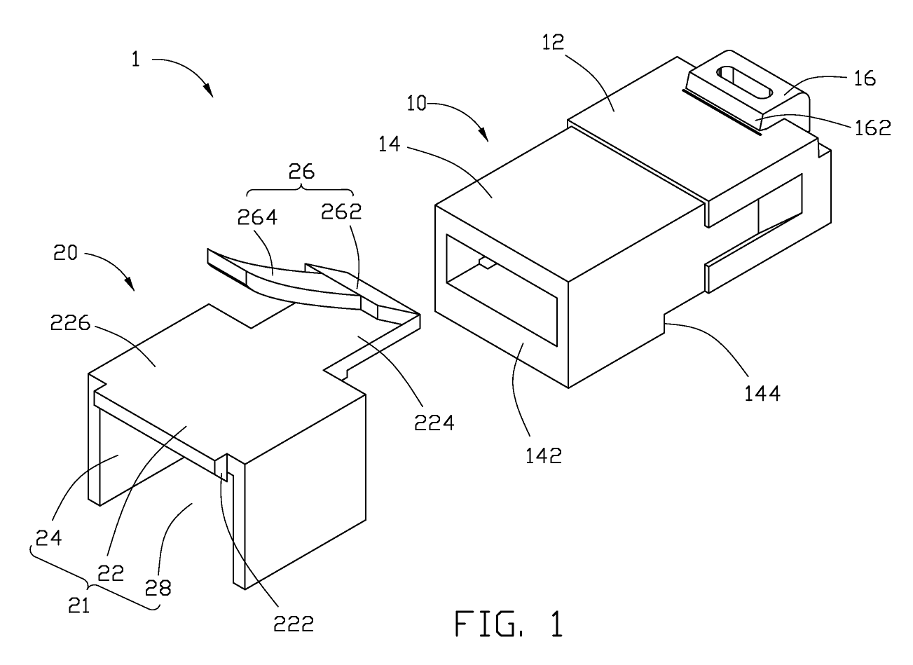

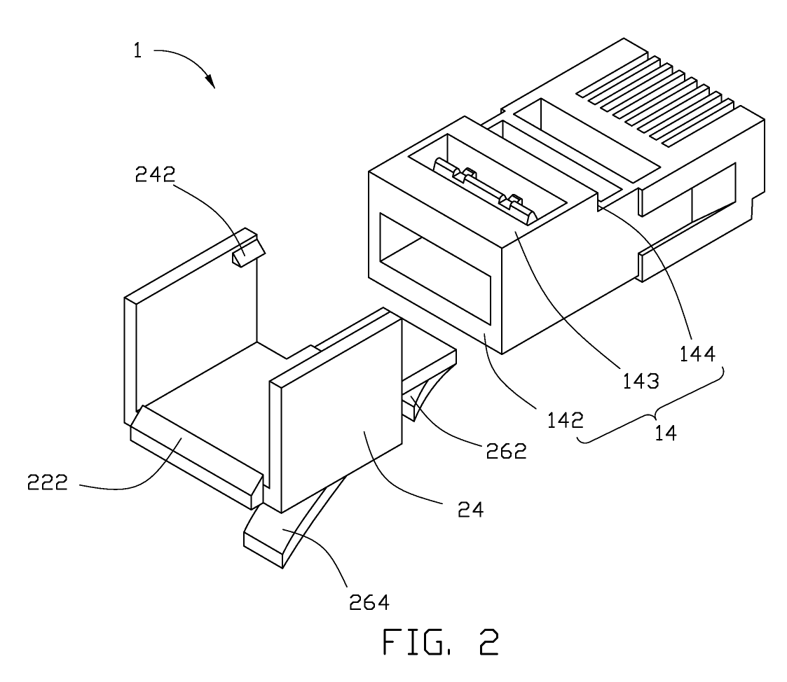

Referring to FIGS. 1 and 2, an exemplary embodiment of a Registered Jack-45 (RJ-45) connector 1 includes a main body 10 and a latching device 20 to engage the main body 10.

The main body 10 includes a fixing portion 14 to latch with the latching device 20, an inserting portion 12 positioned on an end of the fixing portion 14, and a guiding portion 16 positioned on an end of the inserting portion 12 opposite to the fixing portion 14. A first stop wall 162 angled with a top of the inserting portion 12 is formed at an end of the guiding portion 16 and located on the top of the inserting portion 12. The fixing portion 14 is cube-shaped. The fixing portion 14 includes a vertical end wall 142 and a bottom wall 143 extending perpendicular from a bottom of the vertical end wall 142. The bottom wall is stepped and comprises a second stop wall 144 parallel to the end wall 142.

The latching device 20 includes a fixing element 21 and an elastic latching element 26 positioned on an end of the fixing element 21. The fixing element 21 includes a top wall 22 and two sidewalls 24 extending perpendicular down from opposite ends of the top wall 22. The top wall 22 includes a rectangular base 226 and a rectangular protrusion 224 extending from a center of a first side of base 226. A receiving space 28 is bounded by the base 226 and the sidewalls 24, to receive the fixing portion 14 of the main body 10. A first block 222 extends downwards from a second side opposite to the first side of the top wall 22, to resist the end wall 142 of the fixing portion 14. A second block 242 is positioned on an end of an inner surface of each sidewall 24, adjacent to the protrusion 224 to resist the second stop wall 144 of the fixing portion 14.

The latching element 26 is generally T-shaped. The latching element 26 includes a rectangular board 262 angling from a distal end of the protrusion 224 and a wing panel 264 extending from the board 262 opposite to the protrusion 224. The board 262 of the latching element 26 is operated to engage a slot defined in the interface.

The protrusion 224 of the top wall 22 corresponds to the inserting portion 12 of the main body 10. A width of the protrusion 224 is equal to or less than a width of the base 226, to satisfy that the RJ-45 connector 1 can engage an interface of a terminal device.

In other embodiments, the first and second blocks 222, 242 can be positioned on other locations of the latching device 20, to engage the fixing portion 14.

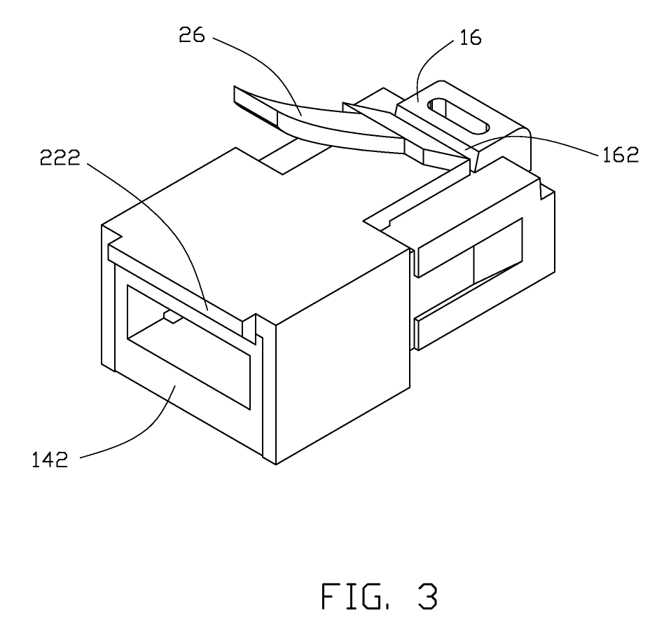

Referring to FIG. 3, in assembly, the latching device 20 is supported on the main body 10, with the fixing portion 14 of the main body received in the receiving space 28 of the latching device 20. The distal ends of the protrusion 224 of the top wall 22 and the board 262 resist the first stop wall 162 of the guiding portion 16. The first stop block 222 of the fixing device 20 resists the end wall 142 of the fixing portion 14, and the second stop block 242 of the fixing device 20 resists the second stop wall 144, to prevent the fixing portion 14 from disengaging from the receiving cavity 28.

In use, the inserting portion 12 of the RJ-45 connector is inserted into the interface. The protrusion 224 of the top wall 22 of the fixing device 20 and the latching element 26 together slide into the interface, guided by the guiding portion 16. As the protrusion 224 of the top wall 22 and the latching element 26 of the fixing device 20 slide into the interface, the latching element 26 is depressed by the interface, until the board 262 of the latching element 26 engages the slot of the interface. The fixing portion 14 of the main body 10, the base 226 of the top wall 22, two sidewalls 24 and the wing panel 264 of the fixing device 20 extend out of the interface.

In other embodiments, the board 262 cannot resist the first stop wall 162 when the latching element 26 slides into the slot of the interface, and the latching element 26 engages the slot of the interface via the board 262 of the latching element 26.

When the RJ-45 connector 1 is to be disengaged from the interface, the swing panel 264 is deformed towards the protrusion 224 to disengage from the interface, such that the RJ-45 connector 1 can be removed from the interface.

If the latching element 26 or other portions of the latching device 20 are broken, the latching device 20 can be removed from the main body 10 and replaced by another new latching device.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

1. A connector, comprising:
a connector main body; and
a latching device detachably engaging the main body, the latching device comprising
a fixing element detachably mounted to the main body; and
an elastic latching element positioned on the fixing element.

2. The connector of claim 1, wherein the fixing element comprises a top wall and two sidewalls extending down from opposite ends of the top wall, and a receiving cavity bounded by the top wall and the two sidewalls to receive the main body, wherein the latching element is positioned on the top wall.

3. The connector of claim 2, wherein the top wall comprises a base and a protrusion extending from a first side of the base, wherein the latching element is positioned on a distal end of the protrusion opposite to the base.

4. The connector of claim 3, wherein the latching element comprises a board angled on the distal end of the protrusion and a wing panel extending from a distal end of the board.

5. The connector of claim 4, wherein the main body comprises a fixing portion, an inserting portion positioned on an end of the fixing portion, and a guiding portion positioned on a distal end of the inserting portion opposite to the fixing portion, wherein a first stop wall angled with a top surface of the inserting portion is formed at an end of the guiding portion to resist the board of the latching element.

6. The connector of claim 5, wherein the fixing portion comprises an end wall opposite to the inserting portion and a bottom wall extending perpendicular from a bottom of the end wall, wherein the bottom wall is stepped and comprises a second stop wall, a first block extends downwards from a side opposite to the protrusion of the top wall to block the end wall of the fixing portion, and a second block is positioned on an inner surface of each of the sidewalls of the fixing element to block the second stop wall.

7-10. (canceled)

11. The connector of claim 1, wherein the connector is a registered Jack-45.
